(19) United States
(12) Patent Application Publication
(10) Pub. No.: US 2026/0178954 A1
(43) Pub. Date: Jun. 25, 2026

(54) METHODS AND SYSTEMS FOR PERFORMING ROBUST PHASE ESTIMATION OF SINGLE- AND MULTI-QUDIT OPERATIONS USING SINGLE-FLUX QUANTUM CONTROL

(71) Applicant: 1QB Information Technologies Inc., North Vancouver (CA)

(72) Inventors: Shunji MATSUURA, Surrey (CA); Alexandre CHOQUETTE-POITEVIN, Montreal (CA); Pooya RONAGH, Guelph (CA)

(21) Appl. No.: 19/319,602

(22) Filed: Sep. 4, 2025

Related U.S. Application Data
(63) Continuation of application No. PCT/IB2024/000574, filed on Mar. 6, 2024.
(60) Provisional application No. 63/488,936, filed on Mar. 7, 2023.
(60) Provisional application No. 63/456,146, filed on Mar. 31, 2023.

(51) Int. Cl. G06N 10/40; G06N 10/20

(52) U.S. Cl. CPC G06N 10/40; G06N 10/20

(57) ABSTRACT

Methods and systems for performing robust phase estimation of single- and multi-qudit gate operations using single-flux quantum (SFQ) control may include: obtaining an indication of a plurality of qudits, wherein at least one qudit of the plurality of qudits is controlled with SFQ control; obtaining an indication of a model representative of the plurality of qudits and single- and multi-qudit gate operations, the model comprising one or more tunable and, optionally, non-tunable parameters; initializing the one or more tunable parameters of the model; using the one or more tunable and, optionally, non-tunable parameters to design one or more quantum circuits; using the one or more tunable parameters' values of the model to set SFQ control parameters; using the SFQ control parameters to execute the one or more quantum circuits; performing a quantum measurement of one or more qudits of the plurality of qudits; and analyzing results of the quantum measurement to infer experimental values of the tunable and, optionally, non-tunable model parameters.

### CROSS-REFERENCE

This application is a continuation of International Application No. PCT/IB2024/000574, filed Mar. 6, 2024, which claims the benefit of U.S. Provisional Application No. 63/488,936, filed Mar. 7, 2023, and of U.S. Provisional Application No. 63/456,146, filed Mar. 31, 2023, each of which applications are incorporated herein by reference in their entireties.

### BACKGROUND

Quantum computing holds the promise of having a significant impact on a wide range of fields, such as optimization, medicine, finance, security, and artificial intelligence. At least one bottleneck in the path toward demonstrating a quantum advantage as well as building fault-tolerant quantum computers is the presence of noise and error. Quantum states on quantum computers may entangle with the environment very easily. The influence of this entanglement with the environment may appear as stochastic noise on quantum states (such as qudit quantum states) and may result in the loss of quantum information, so identifying and quantifying incoherent errors is of significant importance. This type of error is called an incoherent error. There is another type of error called a coherent error. Coherent errors may come from inaccurate quantum control, such as over- or under-rotations of qudits as well as crosstalk between qudits.

Coherent errors may be reversible. In cases where a pure state exists, coherent errors may map a pure state into another pure state. However, the infidelity of coherent errors increases quadratically in the quantum gate number whereas that of incoherent errors increases linearly. Therefore, identifying and quantifying coherent errors is of significant importance as well.

For example, quantum control is prone to errors in part because pulses that control gate operations are analog. For instance, in superconducting quantum computers, qudits are controlled by analog microwave pulses. Rotation angles of qudits depend on strength, shape, and duration time of the pulses. These pulses are generally generated by a classical controller outside of a cryogenic device. This strategy may be challenging from a scalability perspective: for instance, it may use many controllers which take up a lot of physical space, and it may generate heat in the cryogenic device.

### SUMMARY

Disclosed are methods and systems for performing robust phase estimation of single- and multi-qudit operations using single-flux quantum (SFQ) control.

Recognized herein is the need for improved methods and systems that may overcome at least one of the identified drawbacks. The present disclosure provides methods and systems for performing robust phase estimation of single- and multi-qudit operations using SFQ control and uses of the disclosed methods and systems for coherent noise characterization, for the characterization of hardware fabrication defects, and for performing calibration of single- and multi-qudit operations.

In an aspect, the present disclosure provides a method for performing robust phase estimation of single- and multi-qudit gate operations using single-flux quantum (SFQ) control. The method may comprise: (a) obtaining an indication of a plurality of qudits, wherein at least one qudit of said plurality of qudits is controlled with said SFQ control; (b) obtaining an indication of a model representative of said plurality of qudits and single- and multi-qudit gate operations, wherein said model comprises one or more tunable parameters; (c) initializing said one or more tunable parameters of said model; (d) designing one or more quantum circuits based at least in part on said one or more tunable parameters of said model; (e) setting SFQ control parameters based at least in part on values of said one or more tunable parameters of said model; (f) executing said one or more quantum circuits using at least said SFQ control parameters set in (e); (g) performing a quantum measurement of one or more qudits of said plurality of qudits; and (h) inferring experimental values of said tunable parameters of said model based at least in part on results of said quantum measurement, wherein said phase estimation is based at least in part on said experimental values.

In some embodiments, said model comprises one or more non-tunable parameters, and wherein (d) further comprises designing said one or more quantum circuits based at least in part on said one or more non-tunable parameters. In some embodiments, (h) comprises inferring experimental values of said non-tunable parameters of said model based at least in part on said results of said quantum measurement. In some embodiments, (f) and (g) are repeated at least one time. In some embodiments, said tunable and, optionally, non-tunable parameters are representative of at least one member selected from the group consisting of: single-flux quantum (SFQ) control parameters, hardware fabrication properties, and a modulation schedule for current and voltage in a control line.

In some embodiments, the method further comprises: (i) obtaining one or more target single- and multi-qudit gate operations; (j) using said one or more target single- and multi-qudit gate operations to design said one or more quantum circuits in (d); and (k) characterizing coherent noise based at least in part on said quantum measurement. In some embodiments, the method further comprises: (l) adjusting said experimental values of said tunable model parameters in (h) with respect to said target single- and multi-qudit gate operations' values. In some embodiments, (f) and (g) are repeated at least one time. In some embodiments, (e) to (h) are repeated with said experimental values of said tunable parameters adjusted in (l). In some embodiments, (d) to (h) are repeated with said experimental values of said tunable parameters adjusted in (l).

In some embodiments, said non-tunable parameter is representative of hardware fabrication properties, and wherein the method further comprises: characterizing hardware fabrication defects using said single-flux quantum (SFQ) control. In some embodiments, the method further comprises: performing calibration of said single- and multi-qudit gate operations based at least in part on said tunable parameters and, optionally, non-tunable parameters. In some embodiments, said plurality of qudits comprises at least one member of the group consisting of: superconducting qudits, transmon qudits, flux qudits, fluxonium qudits, Cooper-pair boxes, quantronium qudits, phase qudits, hybrid qudits, and cat qudits. In some embodiments, said single- and multi-qudit gate operations comprise at least one member of the group consisting of: a single-qudit rotation gate, a single-qudit Clifford gate, a multi-qudit Clifford gate, a CNOT gate, a Pauli gate, an iSWAP gate, and a CZ gate.

In some embodiments, said single-flux quantum (SFQ) control parameters comprise at least one member of the group consisting of: a schedule of single-flux quantum (SFQ) pulses, the presence or absence of single-flux quantum (SFQ) pulses according to a clock, and a length of a sequence of single-flux quantum (SFQ) pulses. In some embodiments, said modulation schedule for said current and voltage in said control line comprises a plurality of parameters of couplers in a two-qudit gate.

In some embodiments, at least one qudit of said plurality of qudits is controlled with an analog pulse. In some embodiments, said multi-qudit gate comprises one or more multi-qudit couplings. In some embodiments, said one or more multi-qudit couplings are executed using an analog pulse. In some embodiments, said plurality of qudits comprises an error correction code.

In some embodiments, the method further comprises performing an error correction procedure using said error correction code, wherein the error correction procedure is based at least in part on said experimental values of said tunable and, optionally, non-tunable model parameters. In some embodiments, said error correction code comprises CSS code, surface code, colour code, triangular colour code, rotated surface code, or toric code. In some embodiments, the method further comprises: performing a plurality of parity checks on a plaquette in said error correction code.

In another aspect, the present disclosure provides a system for performing robust phase estimation of single- and multi-qudit gate operations using single-flux quantum (SFQ) control. The system may comprise: (a) a quantum computer having: a quantum chip comprising a plurality of qudits; and a control system, wherein at least one qudit of said plurality of qudits is controlled with SFQ control; and (b) a digital computer operatively coupled to said quantum computer, said digital computer comprising a memory having instructions to at least: (i) obtain an indication of a plurality of qudits, wherein at least one qudit of said plurality of qudits is controlled with said SFQ control; (ii) obtain an indication of a model representative of said plurality of qudits and single- and multi-qudit gate operations, wherein said model comprises one or more tunable parameters; (iii) initialize said one or more tunable parameters of said model; (iv) design one or more quantum circuits based at least in part on said one or more tunable parameters of said model; (v) set SFQ control parameters based at least in part on values of said one or more tunable parameters of said model; (vi) execute said one or more quantum circuits using at least said SFQ control parameters set in (v); (vii) perform a quantum measurement of one or more qudits of said plurality of qudits; and (viii) infer experimental values of said tunable parameters of said model based at least in part on results of said quantum measurement, wherein said phase estimation is based at least in part on said experimental values.

In some embodiments, said model comprises one or more non-tunable parameters, and wherein at (iv) said instructions are further configured to design said one or more quantum circuits based at least in part on said one or more non-tunable parameters. In some embodiments, at (viii) said instructions are further configured to infer experimental values of said non-tunable parameters of said model based at least in part on said results of said quantum measurement. In some embodiments, said instructions are further configured to repeat (vi) and (vii) at least one time. In some embodiments, said tunable and, optionally, non-tunable parameters are representative of at least one member selected from the group consisting of: single-flux quantum (SFQ) control parameters, hardware fabrication properties, and a modulation schedule for current and voltage in a control line.

In some embodiments, said instructions are further configured to: (ix) obtain one or more target single- and multi-qudit gate operations; (x) use said one or more target single- and multi-qudit gate operations to design said one or more quantum circuits in (iv); and (xi) characterize coherent noise based at least in part on said quantum measurement. In some embodiments, said instructions are further configured to: (xii) adjust said experimental values of said tunable model parameters in (xiii) with respect to said target single- and multi-qudit gate operations' values. In some embodiments, said instructions are further configured to repeat (vi) and (vii) at least one time. In some embodiments, said instructions are further configured to repeat (v) to (viii) with said experimental values of said tunable parameters adjusted in (xii). In some embodiments, said instructions are further configured to repeat (iv) to (vii) with said experimental values of said tunable parameters adjusted in (xii). In some embodiments, said non-tunable parameter is representative of hardware fabrication properties, and wherein said instructions are further configured to: characterize hardware fabrication defects using said single-flux quantum (SFQ) control. In some embodiments, the instructions are further configured to perform calibration of said single- and multi-qudit gate operations based at least in part on said tunable parameters and, optionally, non-tunable parameters.

In some embodiments, said plurality of qudits comprises at least one member of the group consisting of: superconducting qudits, transmon qudits, flux qudits, fluxonium qudits, Cooper-pair boxes, quantronium qudits, phase qudits, hybrid qudits, and cat qudits. In some embodiments, said single- and multi-qudit gate operations comprise at least one member of the group consisting of: a single-qudit rotation gate, a single-qudit Clifford gate, a multi-qudit Clifford gate, a CNOT gate, a Pauli gate, an iSWAP gate, and a CZ gate.

In some embodiments, said single-flux quantum (SFQ) control parameters comprise at least one member of the group consisting of: a schedule of single-flux quantum (SFQ) pulses, the presence or absence of single-flux quantum (SFQ) pulses according to a clock, and a length of a sequence of single-flux quantum (SFQ) pulses. In some embodiments, said modulation schedule for said current and voltage in said control line comprises a plurality of parameters of couplers in a two-qudit gate.

In some embodiments, at least one qudit of said plurality of qudits is controlled with an analog pulse. In some embodiments, said multi-qudit gate comprises one or more multi-qudit couplings. In some embodiments, said one or more multi-qudit couplings are executed using an analog pulse. In some embodiments, said plurality of qudits comprises an error correction code. In some embodiments, said instructions are further configured to perform an error correction procedure using said error correction code, wherein the error correction procedure is based at least in part on said experimental values of said tunable and, optionally, non-tunable model parameters. In some embodiments, said error correction code comprises CSS code, surface code, colour code, triangular colour code, rotated surface code, or toric code. In some embodiments, said instructions are further configured to perform a plurality of parity checks on a plaquette in said error correction code.

In another aspect, the present disclosure provides a method for performing robust phase estimation of single- and multi-qudit gate operations using single-flux quantum (SFQ) control. The method may comprise: (a) obtaining an indication of a plurality of qudits, wherein at least one qudit of said plurality of qudits is controlled with said single-flux quantum (SFQ) control; (b) obtaining an indication of a model representative of said plurality of qudits and said single- and multi-qudit gate operations, wherein said model comprises one or more tunable parameters; (c) designing one or more quantum circuits based at least in part on said one or more tunable parameters of said model; (d) setting SFQ control parameters based at least in part on values of said one or more tunable parameters of said model; (e) executing said one or more quantum circuits using at least said SFQ control parameters set in (d); and (f) inferring experimental values of said tunable parameters of said model based at least in part on results of a quantum measurement of one or more qubits related to said circuit, wherein said phase estimation is based at least in part on said experimental values.

In another aspect, the present disclosure provides a non-transitory computer-readable medium with instructions stored thereon, which when executed perform the method of any aspect or embodiment herein.

In another aspect, the present disclosure provides a system for performing robust phase estimation of single- and multi-qudit gate operations using single-flux quantum (SFQ) control. The system may comprise: (a) a digital computer operatively coupled to a quantum computer, said digital computer comprising a memory having instructions to at least: (i) obtain an indication of a plurality of qudits, wherein at least one qudit of said plurality of qudits is controlled with said single-flux quantum (SFQ) control; (ii) obtain an indication of a model representative of said plurality of qudits and said single- and multi-qudit gate operations, wherein said model comprises one or more tunable parameters; (iii) design one or more quantum circuits based at least in part on said one or more tunable parameters of said model; (iv) set SFQ control parameters based at least in part on values of said one or more tunable parameters of said model; (v) execute said one or more quantum circuits using at least said SFQ control parameters set in (iv); and (vi) infer experimental values of said tunable parameters of said model based at least in part on results of a quantum measurement of one or more qubits related to said circuit, wherein said phase estimation is based at least in part on said experimental values.

In some embodiments, the system further comprises the quantum computer, wherein the quantum computer comprises: a quantum chip comprising a plurality of qudits; and a control system, wherein at least one qudit of said plurality of qudits is controlled with SFQ control.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a schematic of an example system for performing robust phase estimation of single- and multi-qudit operations using SFQ control, in accordance with some embodiments disclosed herein.

FIG. 2 is a flowchart of an example method for performing robust phase estimation of single- and multi-qudit operations using SFQ control, in accordance with some embodiments disclosed herein.

### DETAILED DESCRIPTION

While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Neither the Title nor the Abstract is to be taken as limiting in any way the scope of the disclosed invention(s). The title of the present application and headings of sections provided in the present application are for convenience only and are not to be taken as limiting the disclosure in any way.

The technology disclosed in this patent document can be implemented in ways to provide s methods and systems that can overcome the limitations associated with performing robust phase estimation of single- and multi-qudit operations using SFQ control. Quantum control is prone to errors in part because pulses that control gate operations are analog. For instance, in superconducting quantum computers, qudits are controlled by analog microwave pulses. Rotation angles of qudits depend on strength, shape, and duration time of the pulses. These pulses are generally generated by a classical controller outside of a cryogenic device. This strategy may be challenging from a scalability perspective: for instance, it may use many controllers which take up a lot of physical space, and it may generate heat in the cryogenic device.

Coherent noise or coherent error may comprise unintended unitary transformations on qudits. Coherent error may generally be reversible. Coherent noise may generally map a pure state into another pure state. Coherent errors may come from inaccurate quantum control, such as over- or under-rotations of qudits as well as crosstalk between qudits. Incoherent noise may comprise noise that is not coherent. Incoherent error may comprise error that is not coherent.

In an example, it may be important in building a quantum computer to calibrate experimentally implemented quantum gates to produce operations that are close to ideal unitaries. A calibration step may comprise estimating the systematic errors in gates and then using controls to correct the implementation. Similarly, a quantum error correction system may comprise a step of characterizing coherent noise and correcting observed over or under rotation errors in gates. In some cases, coherent noise may comprise a phase not being at a theoretical or an ideal or an intended value.

There have been various benchmarking methods proposed for characterizing coherent and incoherent errors. For instance, one randomized benchmarking method (Emerson et al., “Scalable Noise Estimation with Random Unitary Operators”, Journal of Optics B: Quantum and Semiclassical Optics 7, S347, 2005, which is incorporated by reference herein in its entirety) and its variants (e.g., Magesan et al., “Efficient Measurement of Quantum Gate Error by Interleaved Randomized Benchmarking,” Physical Review Letters 109, 080505, 2012, which is incorporated by reference herein in its entirety) use a twirling method to average noise over a certain set of operators, such as Clifford operators or Pauli operators. This twirling method changes the noise channel into simple forms of incoherent errors such as the depolarization channel or Pauli channel. As a result, average gate fidelities can be obtained by looking at the decay rates of success rates as a function of the number of gate operations.

Other methods which allow the investigation of coherent noise are process tomography and gate set tomography. While both provide detailed information about noise, the measurement complexity of these methods may be large. Therefore, they may not be efficient when a particular error in accuracy is considered. Robust phase estimation has been proposed for estimating rotation angles accurately and efficiently (details may be found in Kimmel et al., “Robust calibration of a universal single-qubit gate set via robust phase estimation,” Physical Review A 92, 062315, 2015 and Neill et al., “Accurately computing the electronic properties of a quantum ring,” Nature 594, pp. 508-512, 2021, each of which is incorporated by reference herein in its entirety).

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “of” herein is intended to encompass “and/or” unless otherwise stated.

The term “plurality” generally refers to “two or more,” unless expressly specified otherwise.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, the disclosure includes the disclosure of all possible sub-ranges within such ranges, as well as specific numerical values that fall within such ranges irrespective of whether a specific numerical value or specific sub-range is expressly stated.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

Systems and method disclosed herein may be implemented as part of or with or by a quantum computing system. Quantum computing may be a method of computing which utilizes the concept of quantum superposition and entanglement to manipulate information. Quantum computing may be viewed in contrast to the 0 and 1 binary bits in classical computers. Quantum entanglement may be the phenomenon in which, when multiple qudits interact with each other, their quantum states are entangled and may no longer be represented individually. Entangled quantum states may be generated by unitary transformations involving multi-partite quantum systems. Quantum superposition may be to the principle which states that the quantum state of a qudit can be represented by adding together two or more different quantum states, each associated with a probability. In some cases, the probabilities of all states add to 1. Quantum circuits, consisting of one or more quantum gates, may be designed to perform quantum computation, such as factoring large prime numbers, which may be infeasible or highly inefficient for classical computers. Quantum gates may be logical operators comprising one or multiple qubits, which can be used to perform logical operations.

Classical, as used in the context of computing or computation, may indicate computation performed using binary values using discrete bits without use of quantum mechanical superposition and quantum mechanical entanglement. A classical computer may be a digital computer, such as a computer employing discrete bits (e.g., 0s and 1s) without the use of quantum mechanical superposition and quantum mechanical entanglement. Non-classical, as used in the context of computing or computation, may indicate computational procedures outside of the paradigm of classical computing.

A quantum device may be any device or system for performing computations using quantum mechanical phenomenon such as quantum mechanical superposition or quantum mechanical entanglement. Quantum computations, quantum procedures, quantum operations, quantum computers, etc. may comprise methods or systems for performing computations using quantum mechanical operations. Quantum mechanical operations may comprise unitary transformations or completely positive trace-preserving (CPTP) maps on quantum channels on a Hilbert space represented by a quantum device.

A qubit may comprise a unit of quantum information processing whose quantum state is a complex unit vector of dimension 2. These two dimensions may be referred to as “0” and “1.” A data qubit may comprise one of the qubits used to encode quantum information for a quantum computation. It may contain a part of an input or a part of an output state. If quantum error correction is used, it refers to a logical qubit, and if not, it refers to a physical qubit. A qudit may comprise a multi-level quantum system, e.g., to a qubit in the case of the number of levels in the system being two. A physical qubit may comprise a physical implementation of a qubit. A logical qubit may comprise a qubit viewed as a unit of information, which may be realized by one or more physical qubits. A physical qudit may comprise a physical implementation of a qudit. A logical qudit may comprise a qudit viewed as a unit of information, which may be realized by one or more physical qudits.

A quantum gate operation may comprise a quantum gate, a sequence of quantum gates or a combination of quantum gates and quantum measurements that perform an isometry on the quantum state of qubits. Gates, two-qubit gates, and one-qubit gates may comprise quantum logic gates which are used to perform logical operations. A two-qubit gate may consist of two qubits. A one-qubit gate may consist of one qubit. A quantum chip may comprise a physical device that can utilize quantum phenomena that allows the execution of quantum gates for the purpose of computing.

A circuit may comprise the representation of a computational model in which the computation comprises a sequence of gates. In some cases, a circuit may be used in gate model quantum computation. In some cases, a circuit may be a quantum circuit, such as a sequence of qubit gates used in a gate model quantum computation. A quantum circuit may comprise an initial state preparation for a set of qudits, followed by performing a gate operation and measurements on it. The information stored in physical qubits may, in some cases, be referred to simply as qubits, and the physical qubits and physical qudits of a quantum device as “vertices.” A quantum measurement may comprise a process for extracting classical information from quantum states generated on quantum devices. Quantum hardware may comprise devices on which controllable quantum states may be realized. A qudit quantum state may comprise a state of qudits which can be described as a wavefunction or a density matrix in quantum mechanics. There are various methods of realizing qubits and qudits using physical implementations. One method is via superconducting qubits and qudits, and another involves the use of ion trap qubits and qudits, but it should be understood that other methods may be used. The number of methods of realizing qubits and qudits is growing. Hereafter, when referring to “qubits” it should be assumed that what is described may also refer to “qudits,” and vice versa.

### Multi-Level Quantum System

A multi-level quantum system may be structured in a way which operates based on quantum mechanical processes such as superposition and entanglement of quantum states. A multi-level system can include a system with two or more energy states of an artificial or a natural atom, for example, the ground state (|0>) and first excited state (|1>) of an artificial atom. The artificial atom may be a superconducting artificial atom. Such a multi-level system can have 0, 1, . . . , n energy states. A multi-level quantum system may be referred to as a qudit and multiple qudits may be used to implement a quantum computing system. A qudit may be thought of as one of n quantum states 0, 1, . . . , n−1 or a superposition of any of the n states. Specific subcategories of qudits exist, including a system comprising two energy states, the ground state (|0>) and first excited state (|1>). These two-state systems may be referred to as qubits. Each qubit can be placed in one of these two states. However, due to the nature of multi-level quantum systems, they can also be placed in a superposition of these two states. Entangled qubits or qudits can perform computational tasks.

### Single-Flux Quantum (SFQ) Technology

A single-flux quantum (SFQ) may be a single quantum of magnetic flux. For example, a single quantum of magnetic flux may be generated using an electronic device that uses one or more Josephson junctions to generate and/or process digital signals. An SFQ-based control technique may be a digital approach to resolving issues of scalability related to the control of quantum systems, such as, for example, physical space and heat. SFQ control may be a control technique that utilizes single-flux quanta for control. Further description of single-flux quantum control is described further at, for example, McDermott et al., “Accurate Qubit Control with Single Flux Quantum Pulses,” Physical Review Applied 2, 014007, 2014 and Li et al., “Hardware-Efficient Qubit Control with Single-Flux-Quantum Pulse Sequences,” Physical Review Applied 12, 014044, 2019, each of which is incorporated herein by reference in its entirety.

Accurate quantum control may be useful for reliable quantum computing. One possible architecture is superconducting quantum computers that make use of Josephson qudits. One challenge to building large-scale superconducting quantum computers is related to quantum control, such as sending accurate microwave signals to control thousands of qudits, reducing the number of required control wires, etc. Another challenge is related to the wiring heat load. SFQ pulses have been introduced to mitigate these problems. SFQ pulses may enable the digital control of qudits by using fluxons in superconducting qudits. The accuracy of SFQ-based control may be due in part to the fact that time integration of a voltage pulse has a quantized value h/2e, where h is a Planck constant and e is an electric charge. Furthermore, an SFQ technology is cryogenic, which may address at least some of the problems resulting from heat load from control wiring as well as the number of required wires, and is also in situ.

### NISQ Technology—Noisy Intermediate-Scale Quantum Technology

The term “noisy, intermediate-scale quantum” (NISQ) was introduced in Preskill, “Quantum Computing in the NISQ era and beyond,” arXiv:1801.00862, 2018, which is incorporated herein by reference in its entirety. Here, the term “noisy” implies that there may be incomplete control over the qudits, and “intermediate-scale” refers to the number of qudits, which may range from about 50 to about a few hundred. Several physical systems made from superconducting qudits, artificial atoms, or ion traps have been proposed thus far as feasible candidates to build NISQ devices and, ultimately, universal quantum computers.

Methods and systems disclosed herein may be suitable for a NISQ device. In some cases, a NISQ device with a limitation of a two-dimensional structure of a quantum chip or a limitation on how many neighbouring qubits (or qudits) each qubit (or qudit) is connected to may benefit from methods and systems disclosed herein.

### Quantum Device/Quantum Hardware

Any type of non-classical computer, for example, a quantum computer, may be suitable for the technologies disclosed herein. In some cases, a quantum device with a limitation of a two-dimensional structure of a quantum chip or a limitation on how many neighbouring qubits (or qudits) each qubit (or qudit) is connected to may benefit from methods and systems disclosed herein. In accordance with the description herein, suitable quantum computers may include, by way of non-limiting examples: superconducting quantum computers (qubits implemented as small superconducting circuits-Josephson junctions) (Clarke et al., “Superconducting quantum bits,” Nature 453, no. 7198, pp. 1031-1042, 2008); trapped-ion quantum computers (qubits implemented as states of trapped ions) (Kielpinski et al., “Architecture for a large-scale ion-trap quantum computer,” Nature 417, no. 6890, pp. 709-711, 2002); optical lattice quantum computers (qubits implemented as states of neutral atoms trapped in an optical lattice) (Deutsch et al., “Quantum computing with neutral atoms in an optical lattice,” Fortschritte der Physik: Progress of Physics 48, no. 9-11, pp. 925-943, 2000); spin-based quantum dot computers (qubits implemented as the spin states of trapped electrons) (Imamoglu et al., “Quantum information processing using quantum dot spins and cavity QED,” Physical Review Letters 83, no. 20, p. 4204, 1999); spatial-based quantum dot computers (qubits implemented as electron positions in a double quantum dot) (Fedichkin et al., “Novel coherent quantum bit using spatial quantization levels in semiconductor quantum dot,” arXiv:quant-ph/0006097, 2000); coupled quantum wires (qubits implemented as pairs of quantum wires coupled by quantum point contact) (Bertoni et al., “Quantum logic gates based on coherent electron transport in quantum wires,” Physical Review Letters 84, no. 25, p. 5912, 2000); nuclear magnetic resonance quantum computers (qubits implemented as nuclear spins and probed by radio waves) (Cory et al., “Nuclear magnetic resonance spectroscopy: An experimentally accessible paradigm for quantum computing,” arXiv:quant-ph/9709001, 1997); solid-state NMR Kane quantum computers (qubits implemented as the nuclear spin states of phosphorus donors in silicon) (Kane, “A silicon-based nuclear spin quantum computer,” Nature 393, no. 6681, pp. 133-137, 1998); electrons-on-helium quantum computers (qubits implemented as electron spins) (Lyon, “Spin-based quantum computing using electrons on liquid helium,” arXiv:cond-mat/0301581, 2006); molecular magnet-based quantum computers (qubits implemented as spin states) (Leuenberger et al., “Quantum Computing in Molecular Magnets,” arXiv:cond-mat/0011415, 2001); fullerene-based ESR quantum computers (qubits implemented as electronic spins of atoms or molecules encased in fullerenes) (Harneit, “Spin Quantum Computing with Endohedral Fullerenes,” arXiv:1708.09298, 2017); diamond-based quantum computers (qubits implemented as electronic or nuclear spins of nitrogen-vacancy centres in diamond) (Nizovtsev et al., “A quantum computer based on NV centers in diamond: optically detected nutations of single electron and nuclear spins,” Optics and spectroscopy 99, no. 2, pp. 233-244, 2005); Bose-Einstein condensate-based quantum computers (qubits implemented as two-component BECs) (Byrnes et al., “Macroscopic quantum computation using Bose-Einstein condensates,” arXiv:quantum-ph/1103.5512, 2011); transistor-based quantum computers (qubits implemented as semiconductors coupled to nanophotonic cavities) (Sun et al., “A single-photon switch and transistor enabled by a solid-state quantum memory,” arXiv:quant-ph/1805.01964, 2018); metal-like carbon nanospheres based quantum computers (qubits implemented as electron spins in conducting carbon nanospheres) (Nifridi et al., “Room temperature manipulation of long lifetime spins in metallic-like carbon nanospheres,” arXiv:cond-mat/1611.07690, 2016); topological quantum computers (qubits implemented as non-Abelian anyons) (Nayak et al., “Non-Abelian Anyons and Topological Quantum Computation,” arXiv:0707.1889, 2007); photonic continuous-variable quantum computing hardware (quantum variables represented by the quadrature operators of the quantum harmonic oscillators in a quantum optical mode) (Arrazola et al., “Quantum circuits with many photons on a programmable nanophotonic chip,” Nature 591, pp. 54-60, 2021); photonic qubit-based quantum hardware (qubits implemented on pairs of optical paths) (O'Brien et al., “Photonic quantum technologies,” Nature Photonics 3, pp. 687-695, 2009); quantum computing hardware based on bosonic codes (error-protected qubits or qudits are formed by embedding a finite-dimensional code space within the infinite-dimensional Fock space associated with a bosonic quantum field mode; examples include the Gottesman-Kitaev-Preskill (GKP) code, cat codes, and binomial codes, respectively) (Gottesman et al., “Encoding a qubit in an oscillator,” Physical Review A 64, 012310, 2001; Chamberland et al., “Building a Fault-Tolerant Quantum Computer Using Concatenated Cat Codes,” PRX Quantum 3, 010329, 2022; Michael et al., “New Class of Quantum Error-Correcting Codes for a Bosonic Mode,” Physical Review X 6, 031006, 2016); quantum hardware based on coherent network computing (operating by sampling low-energy eigenstates of an Ising Hamiltonian by encoding the spins in a network of optical parametric oscillators with all-to-all connectivity; future architectures may exploit quantum entanglement for computation) (Inui et al., “Entanglement and quantum discord in optically coupled coherent Ising machines,” Physical Review A 102, 062419, 2020; and Yanagimoto et al., “Embedding entanglement generation within a measurement-feedback coherent Ising machine,” arXiv:1906.04902, 2019); each of which is incorporated herein by reference in its entirety.

Methods and systems disclosed herein may be suitable for a device which simulates a quantum computer. For example, methods and systems disclosed herein may be suitable for a device which exploits quantum mechanical properties, but which comprises a limited number of gate operations or which does not implement a series of qudit gate operations. In some cases, a device which simulates a quantum computer with a limitation of having a two-dimensional structure of a quantum chip or a limitation on how many neighbouring qubits (or qudits) each qubit (or qudit) is connected to may benefit from methods and systems disclosed herein.

### Quantum Error Correcting Codes

A quantum error correcting code (QECC) may be implemented by constructing one or more working logical qudits with a relatively low error rate from several physical data qudits with a relatively higher error rate. A QECC may be characterized by several parameters, including, for example, the number of data qudits (denoted by n), the number of logical qudits (denoted by k), and the minimum number of errors which maps one logical state to another (called the code distance and denoted by d).

An error correcting code or error correction code may be a quantum code which has the capacity or is designed with the intent to correct errors in quantum processes.

In some implementations, QECCs may be constructed as a natural extension of classical error correcting codes (ECC), which can encode one or more logical bits using many low-fidelity bits by correcting errors, such as bit-flip errors.

An example class of QECCs is stabilizer codes. The general stabilizer formalism may be given as follows. An abelian subgroup K of the n-qudit Pauli group is chosen. This is called the stabilizer subgroup. A set of generators A₁, A₂, . . . , Aₘ is chosen for K. The code space is the space of states of the data qudits which are stabilized by A, that is, eigenstates with an eigenvalue of +1. The code space therefore encodes n−m logical qudits. Simultaneously measuring each of the stabilizers A₁, A₂, . . . , Aₘ projects the data state to the code space. Details may be found in Gheorghiu, “Standard Form of Qudit Stabilizer Groups,” arXiv:1101.1519, 2011 and Gottesman, “An Introduction to Quantum Error Correction and Fault-Tolerant Quantum Computation,” arXiv:0904.2557, 2009, each of which is incorporated by reference herein in its entirety.

One embodiment of stabilizer codes is CSS codes. CSS codes may be constructed using the Calderbank-Shor-Steane (CSS) construction, which produces a single QECC from two nested linear ECCs, C′<C, with the same number of data bits. The logical qubit is encoded within the subquotient C/C′. The reason this construction produces a QECC is that (1) the ability to correct both Pauli-X (bit-flip) errors and Pauli-Z (phase-flip) errors may enable full quantum error correction, and (2) application of the Hadamard gate flips a code to its dual, and interchanges X errors for Z errors. For CSS codes, each stabilizer generator is either a Z-type generator or an X-type generator. (Calderbank et al., “Good quantum error-correcting codes exist,” Physical Review A 54, p. 1096, 1996; Steane, “Error Correcting Codes in Quantum Theory,” Physical Review Letters 77, p. 793, 1996; and Chapter 10 of Nielsen et al., “Quantum Computation and Quantum Information”, 10th Anniversary Edition, ISBN 978-1-107-00217-3, Cambridge University Press, 2010; each of which is incorporated by reference herein in its entirety.)

The quantum error correction procedure can be implemented as follows. At regular time intervals, syndrome extraction circuits comprising data qudits and syndrome qudits are executed. Such a syndrome extraction circuit operates a sequence of physical qudit gates and performs a stabilizer measurement to produce readouts from the syndrome qudits. This collection of readouts may comprise a syndrome. This syndrome data provides incomplete information about the error that has occurred, and the information is sent to the classical decoder, which infers the most likely error which caused that syndrome. The decoder returns a candidate recovery operation, which is then applied to the data qudits.

Various classical algorithms have been developed to perform efficient and accurate decoding, depending on the one or more error correcting codes used. Some examples and their implementation details can be found in Chamberland et. al., “Triangular color codes on trivalent graphs with flag qubits,” arXiv:1911.00355, 2020; Kubica et al., “Efficient color code decoders in d≥2 dimensions from toric code decoders,” arXiv:1905.07393v1, 2019; Delfosse et al., “Almost-linear time decoding algorithm for topological codes,” arXiv:1709.06218v1, 2017; and Brown et al., “Fault-tolerant error correction with the gauge color code,” arXiv:1503.08217v1, 2015; each of which is incorporated by reference herein in its entirety.

In some implementations, an algorithm may be performed on a special-purpose classical decoder which is external to the quantum processor. For example, the special-purpose decoder may operate at a sufficiently low cryogenic temperature and may be placed in the physical proximity of the quantum processor at a desired low cryogenic temperature enabling communication lag minimization. As a specific example, the special-purpose decoder may be placed at a suitable cryogenic temperature in the range of a few millikelvins (mK) to several kelvins (K), such as 10 mK, 100 mK, 600 mK, 3 K, or 4 K, and the cryogenic temperature of the quantum processor may be at a few mK or a few tens of mK.

More details on quantum error correction techniques can be found in Devitt et al., “Quantum Error Correction for Beginners,” arXiv:0905.2794, 2013 and Chapter 10 of Nielsen et al., “Quantum Computation and Quantum Information,” 10th Anniversary Edition, ISBN 978-1-107-00217-3, Cambridge University Press, 2010, each of which is incorporated by reference herein in its entirety.

A topological error correcting code may be a stabilizer code where the qudits obey a fixed physical layout. The logical qudit space may be identified with the second homology group of the surface containing the qudits. In this situation, each stabilizer generator corresponds to a two-dimensional face on the surface, forming a plaquette. A plaquette may be a group of qudits that form a closed loop.

### Digital Computer

In some cases, a digital computer comprises one or more hardware central processing units (CPU) that carry out the digital computer's functions. In some cases, the digital computer further comprises an operating system (OS) configured to perform executable instructions. In some cases, the digital computer is connected to a computer network. In some cases, the digital computer is connected to the Internet such that it accesses the World Wide Web. In some cases, the digital computer is connected to a cloud computing infrastructure. In some cases, the digital computer is connected to an intranet. In some cases, the digital computer is connected to a data storage device.

In accordance with the description herein, suitable digital computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use in some cases of the method and the system described herein. Select televisions, video players, and digital music players, in some cases with computer network connectivity, may be suitable for use with one or more variations, examples, or embodiments of the systems and the methods described herein. Suitable tablet computers may include those with booklet, slate, and convertible configurations.

In some cases, the digital computer comprises an operating system configured to perform executable instructions. The operating system may be, for example, software, comprising programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3@, Sony® PS4@, Microsoft® Xbox 360@, Microsoft® Xbox One®, Nintendo® Wii®, Nintendo® Wii U®, and Ouya®.

In some cases, the digital computer comprises a storage and/or memory device. In some cases, the storage and/or memory device is one or more physical apparatuses used to store data or programs on a temporary or permanent basis. In some cases, the device comprises a volatile memory and requires power to maintain stored information. In some cases, the device comprises non-volatile memory and retains stored information when the digital computer is not powered. In some cases, the non-volatile memory comprises a flash memory. In some cases, the non-volatile memory comprises a dynamic random-access memory (DRAM). In some cases, the non-volatile memory comprises a ferroelectric random-access memory (FRAM). In some cases, the non-volatile memory comprises a phase-change random-access memory (PRAM). In some cases, the non-volatile memory comprises resistive random-access memory (RRAM). In some cases, the device comprises a storage device including, by way of non-limiting examples, CD-ROMs, DVDs, flash memory devices, magnetic disk drives, magnetic tapes drives, optical disk drives, and cloud computing-based storage. In some cases, the storage and/or memory device comprises a combination of devices, such as those disclosed herein.

In some cases, the digital computer comprises a display used for providing visual information to a user. In some cases, the display comprises a cathode ray tube (CRT). In some cases, the display comprises a liquid crystal display (LCD). In some cases, the display comprises a thin film transistor liquid crystal display (TFT-LCD). In some cases, the display comprises an organic light-emitting diode (OLED) display. In some cases, an OLED display comprises a passive-matrix OLED (PMOLED) or active-matrix OLED (AMOLED) display. In some cases, the display comprises a plasma display. In some cases, the display comprises a video projector. In some cases, the display comprises a combination of devices, such as those disclosed herein.

In some cases, the digital computer comprises an input device to receive information from a user. In some cases, the input device comprises a keyboard. In some cases, the input device comprises a pointing device including, by way of non-limiting examples, a mouse, trackball, trackpad, joystick, game controller, or stylus. In some cases, the input device comprises a touch screen or a multi-touch screen. In some cases, the input device comprises a microphone to capture voice or other sound input. In some cases, the input device comprises a video camera or other sensor to capture motion or visual input. In some cases, the input device comprises a Kinect®, Leap Motion®, or the like. In some cases, the input device comprises a combination of devices, such as those disclosed herein.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be used, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

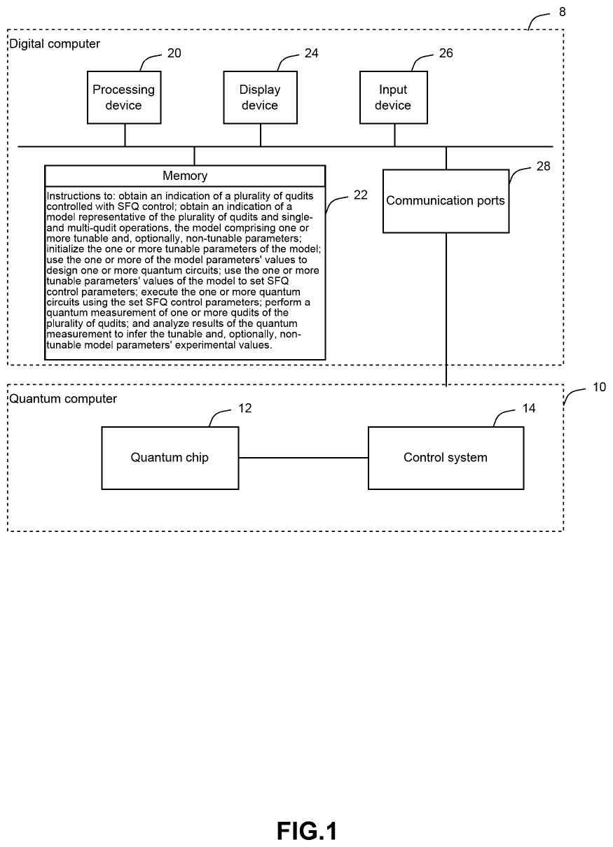

Now referring to FIG. 1, there is shown a schematic of an example system for performing robust phase estimation of single- and multi-qudit gate operations using SFQ control. The system comprises i) a classical computer which in this embodiment is a digital computer 8, and ii) a quantum computer 10. The digital computer 8 may be any digital computer disclosed elsewhere herein.

In some cases, the quantum computer 10 comprises a quantum chip 12. The quantum chip 12 comprises a plurality of qudits. In some cases, the quantum computer 10 comprises a control system 14, wherein at least one qudit of the plurality of qudits is controlled with SFQ pulses. The quantum computer 10 may be operatively connected to the digital computer 8 by way of connection between the control system 14 and communications ports 28. The quantum computer 10 may comprise any quantum computer such as any quantum device or quantum hardware disclosed herein.

In some cases, the digital computer 8 is for providing instructions to the quantum computer 10 using the communications ports 28 and the control system 14.

In some cases, the digital computer 8 comprises a processing device 20, a display device 24, an input device 26, communication ports 28, and a memory 22. The processing device 20, the display device 24, the input device 26, the communication ports 28, and the memory 22 may be of various types, such as any type disclosed elsewhere herein. The memory 22 comprises a computer program executable by the processing device 20. In some cases, the communication ports 28 communicate with the quantum computer 10 via the control system 14.

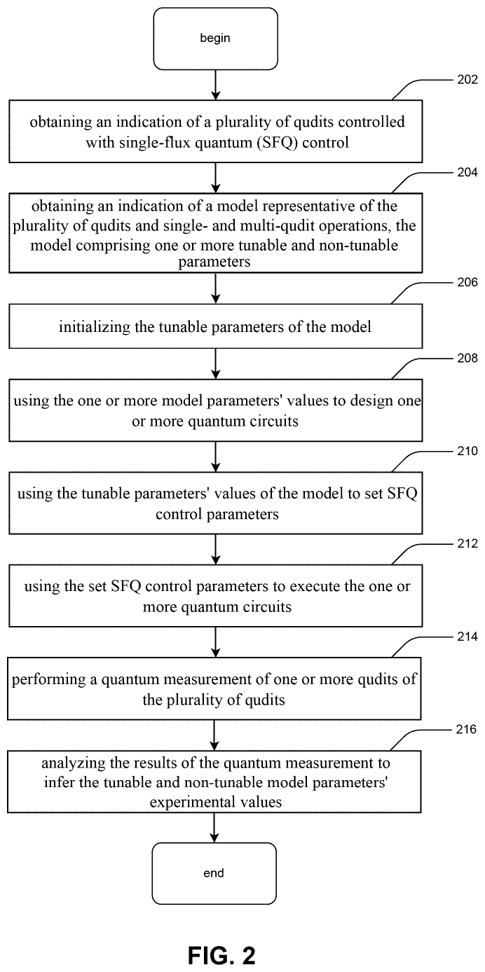

Now referring to FIG. 2, there is shown a flowchart of an example method for performing robust phase estimation of single- and multi-qudit gate operations using SFQ control.

According to processing operation 202, an indication of a plurality of qudits controlled with SFQ control is obtained. The qudits may be of various types. In some cases, the qudits are superconducting qudits, such as transmon qudits, flux qudits, fluxonium qudits, Cooper-pair boxes, quantronium qudits, phase qudits, hybrid qudits, or cat qudits.

The plurality of qudits may be a part of a quantum chip of a quantum computer. The quantum computer may be of various types, such as any quantum computer disclosed elsewhere herein. In some cases, the quantum computer is the quantum computer 10 disclosed herein with respect to FIG. 1. The quantum computer may comprise a control system wherein at least one qudit of the plurality of qudits is controlled with SFQ pulses. In some cases, the control system is the control system 14 disclosed herein with respect to FIG. 1.

In SFQ control, a time-dependent voltage source may be coupled capacitively to a resonator. Classical bits of information may be stored as the presence or absence of a phase slip across a Josephson junction in a given clock cycle. The phase slip may result in a voltage pulse whose time integral is quantized to Φ₀=h/2e, the superconducting flux quantum. In some cases, SFQ pulse amplitudes may be on the order of 1 mV and pulse durations may be around 2 ps, roughly two orders of magnitude shorter than the typical qubit oscillation period. As a result, an SFQ pulse may impart a delta function-like kick to the qubit that induces a coherent rotation in the qubit subspace (details may be found in Li et al., “Hardware-Efficient Qubit Control with Single-Flux-Quantum Pulse Sequences,” Physical Review Applied 12, 014044, 2019, which is incorporated herein by reference in its entirety). A single SFQ pulse may deposit quantized energy to the resonator. By sending a sequence of pulses while setting the pulse separation time to match the resonator period, a quantum-state-specific amount may be rotated along a specific direction.

Still referring to FIG. 2 and according to processing operation 204, an indication of a model representative of the plurality of qudits and single- and multi-qudit operations is obtained. The model comprises tunable and non-tunable parameters.

In some embodiments, a tunable coupler architecture is used, where, in practice, a frequency-tunable transmon qubit mediates the interaction between two fixed-frequency qubits that are neighbouring it. By using one of an iSWAP-like gate to attain an arbitrary swap angle, θ, and a CPHASE gate that generates an arbitrary conditional phase, φ, an arbitrary two-qubit gate within the excitation-preserving subspace may be executed, allowing for a complete implementation. This gate is called a fermionic simulation gate, or fSim gate. Further description of the fSim gate can be found at, for example, Foxen et al., “Demonstrating a Continuous Set of Two-Qubit Gates for Near-Term Quantum Algorithms,” Physical Review Letters 125, 120504, 2020, which is incorporated by reference herein in its entirety.

In terms of Pauli operators and tunable and non-tunable parameters, the fSim gate is given by

$$f S i m ( θ , ϕ , {α}_{+} , {α}_{-} ) = exp [ i ( θ \frac{X X + Y Y}{2} + {α}_{+} ( ZI + IZ ) + {α}_{-} ( ZI - IZ ) + ϕZZ ) ] .$$

Here, X represents the Pauli matrix

$$X = ( \begin{matrix}0 & 1 \\ 1 & 0\end{matrix} ) ,$$

Y represents the Pauli matrix

$$Y = ( \begin{matrix}0 & - i \\ i & 0\end{matrix} ) ,$$

and Z represents the Pauli matrix

$$Z = ( \begin{matrix}1 & 0 \\ 0 & - 1\end{matrix} ) .$$

Each fSim gate acts on two qubits. For instance, ZI represents the action of Pauli-Z on the first qubit and I on the second qubit.

The tunable and non-tunable parameters may be representative of various properties and controls and parameters. The tunable and non-tunable parameters may be representative of at least one of SFQ control parameters, hardware fabrication properties, or modulation schedule for current and voltage in the control line. A modulation schedule for current and voltage in the control line may be a scheme for adjusting current and voltage on quantum devices.

In some embodiments, θ, α₊, and φ are defined by an SFQ pulse sequence. For example, θ may be determined by how many SFQ pulses which induce (XX+YY)/2 kicks are sent to the qubits of interest as well as other parameters such as a coupling capacitance between an SFQ driver and a qubit, a qudit self-capacitance, and a qudit fundamental transition frequency. The same is true for α₊ and φ, except for the Pauli operators. As a consequence, these parameters are tunable. On the other hand, α₋ is set by the fabrication of the qubit chip. Therefore, it is a non-tunable parameter.

In some cases, the SFQ control parameters may comprise a schedule of SFQ pulses, the presence or absence of SFQ pulses according to a clock, a length of a sequence of SFQ pulses, etc. A high-speed SFQ clock that delivers pulses to the transmon qudit according to a vector of binary variables {bₖ} with bₖ∈{0,1} may be considered. Here, bₖ=0 if no SFQ pulse is applied on the i-th clock edge and bₖ=1 if an SFQ pulse is applied. Using these expressions, the total time evolution operator of the gate U_{G}, time ordered in terms of clock edges, may be written as

$${U}_{G} = T \{ {Π}_{i}^{N} ( {δ}_{{b}_{i} , 1} {U}_{fr} ( {T}_{c} ) {U}_{S F Q} + {δ}_{{b}_{i} , 0} {U}_{fr} ( {T}_{c} ) ) ,$$

where N is the number of clock cycles in the sequence and T_{c} is the clock period. Here U_{fr} represents the free evolution of the transmon qudits and U_{SFQ} represents the unitary evolution induced by an SFQ pulse.

In some cases, the modulation schedule for current and voltage in the control line may comprise parameters of couplers in a two-qudit gate. In some embodiments, a sequence of SFQ pulses is sent to turn on (XX+YY) coupling in the fSim(θ, φ, α₊, α₋) defined above. In terms of the unitary transformation,

$${U}_{SFQ} ∼ exp ( i f ( {Φ}_{0} ) \frac{X X + Y Y}{2} ) ,$$

where Φ₀=h/2e. f is a function of Φ₀ and other parameters such as a coupling capacitance between an SFQ driver and a qudit. This may generate an iSWAP gate. More-general gates may be generated by combining a sequence of SFQ pulses for single-qubit gates and an iSWAP gate.

The single- and multi-qudit operations may be of various types such as any quantum gate operation described elsewhere herein. In some cases, the single- and multi-qudit operations may comprise a single-qudit rotation gate, a single-qudit Clifford gate, a multi-qudit Clifford gate, a CNOT gate, a Pauli gate, an iSWAP gate, a CZ gate, etc. The set of single- and multi-qudit operations needs to be a universal gate set, which enables performing any unitary operations.

The indication of the model representative of the plurality of qudits and single- and multi-qudit operations may be obtained in various ways.

In some cases, the indication of the model representative of the plurality of qudits and single- and multi-qudit operations may be obtained using a digital computer. The digital computer may be of various types, such as any digital computer disclosed elsewhere herein. In some cases, the digital computer may be the digital computer 8 disclosed herein with respect to FIG. 1. The indication of the model representative of the plurality of qudits and single- and multi-qudit operations may be stored in a storage (not shown) or a memory disclosed herein. In some cases, the memory device may be the memory 22 disclosed herein with respect to FIG. 1 of the digital computer 8.

In some cases, the indication of the model representative of the plurality of qudits and single- and multi-qudit operations may be provided by a user interacting with the digital computer 8 disclosed herein with respect to FIG. 1.

In some cases, the indication of the model representative of the plurality of qudits and single- and multi-qudit operations may be obtained from a remote processing unit, not shown, operatively coupled with the digital computer 8 disclosed herein with respect to FIG. 1. The remote processing unit may be operatively coupled with the digital computer 8 in various ways. In some cases, the remote processing unit may be coupled with the digital computer 8 via a network disclosed elsewhere herein. In some cases, the network may be a data network. The data network may be selected from a group consisting of a local area network (LAN), a metropolitan area network (MAN), and a wide area network (WAN). In one example, the data network comprises the Internet.

In some cases, the indication of the model representative of the plurality of qudits and single- and multi-qudit operations may be obtained from a computer-implemented method for performing robust phase estimation of single- and multi-qudit gate operations using SFQ control.

Still referring to FIG. 2 and according to processing operation 206, the tunable parameters of the model are initialized. The tunable parameters of the model may be initialized in various ways. The values for initialization may be obtained in various ways. In some embodiments, a model describing qudits in which qudit couplings are determined by the amount of external flux is used. In the framework of SFQ pulse gate operations, the fidelity of the gate operations as well as the amount of leakage may depend on qudit couplings, the type of pulses representing which couplings are turned on, and on their schedules. In some embodiments, the tunable parameters in single-qudit control are the schedules of SFQ pulses. The schedules of X pulses, Y pulses, and the absence of pulses may determine the accuracy of the gate operations. In some cases, a classical computer may be used to find an optimal amount of flux, and to find pulse schedules so that a quantum computer may generate the intended gate operations. In some cases, an optimal amount of flux may comprise an amount of flux which generates an intended gate operation. In some cases, an optimal amount is an approximately optimal amount or an improved amount of flux as disclosed herein. In some cases, optimal, approximately optimal, or significantly improved pulse schedules may be determined by using a quantum computer directly. In some cases, an optimal pulse schedule may be a schedule which generates an intended gate operation.

Still referring to FIG. 2 and according to processing operation 208, the one or more model parameters' values are used to design one or more quantum circuits. A quantum circuit may be designed so that the measurement results, such as expectation values of Pauli operators, are functions of the parameters. In some embodiments, a single-qubit rotation exp(−iθY), where Y is the Pauli matrix

$$( \begin{matrix}0 & - i \\ i & 0\end{matrix} ) ,$$

is used. Initializing a qubit's state to |0 [symbol] , and applying the gate n times, the quantum state may be evolved to cos(nθ)|0 [symbol] +sin(nθ)|1 [symbol] . The expectation value of Pauli-Z is cos(2nθ), which is a function of the number of applications of the gate n and the rotation angle θ that the quantum device has performed.

Still referring to FIG. 2 and according to processing operation 210, the tunable parameters' values of the model are used to set SFQ control parameters. In the above cases, θ is a tunable parameter. In SFQ control, a certain value is not directly realized on a quantum device. The sequence of SFQ pulses may be determined (the binary string as well as the separation T between the pulses), which realizes a rotation of a specific angle θ. Each pulse rotates a qudit by a certain angle δθ, which is determined by fundamental constants such as the Planck constant h as well as tunable and non-tunable coupling parameters. The number of pulses M may be selected so that P×δθ is as close as possible to θ.

Still referring to FIG. 2 and according to processing operation 212, the set SFQ control parameters are used to execute the one or more quantum circuits. In some cases, the one or more quantum circuits may be executed on the quantum hardware. The quantum hardware may be of various types, such as any quantum computer disclosed elsewhere herein. In some cases, the quantum hardware may be the quantum computer 10 disclosed herein with respect to FIG. 1. A quantum circuit with a different number of gate operations may be executed. The measurement results are functions of the SFQ tunable parameters as well as the number of gate operations. In some cases, additional gates between the gate operations may be added, so that the parameter values can be separated. In some embodiments, single-qubit Z-rotations are applied, followed by the two-qubit gate:

$${f}_{c} ≡ Rz ( - \frac{z}{2} ) ⊗ R z ( \frac{z}{2} ) \cdot exp [ i ( θ \frac{XX + YY}{2} + {α}_{+} ( ZI + IZ ) + {α}_{-} ( ZI - IZ ) + ϕ Z Z ) ] ,$$

where the two-qubit gate requires calibration. The parameters z in Rz are introduced so that measurement results have different dependencies on the parameters.

Still referring to FIG. 2 and according to processing operation 214, a quantum measurement of one or more qudits of the plurality of qudits is performed. In some cases, the control system 14 disclosed herein with respect to FIG. 1 is used for quantum measurement readouts. In some cases, the quantum measurement may be performed in the Z-basis, the X-basis, or the Y-basis. In some cases, random unitary operation is applied, and the quantum measurement may be performed in the Z-basis. The information of SFQ pulse parameters is in the expectation values of the Pauli operators (the tensor products of X, Y, and Z). They may be measured directly, or a classical shadow scheme may be used in order to compute expectation values of Pauli operators efficiently and simultaneously. In some embodiments, if f_{c} is applied n times on an initial two-qubit state |10 [symbol] and the expectation value of ZI is measured, then the dependency on n of the expectation value is −A cos 2nδ, where A is a function of θ, γ, and δ, but not n. From the periodicity of the expectation value with respect to n, the parameter value δ realized on a quantum device may be determined. The robustness of this method comes from the fact that decoherence errors do not change the periodicity of the measurement results.

In some cases, the quantum measurement of one or more qudits of the plurality of qudits may be performed using a control system of a quantum computer. The quantum computer may be of various types, such as any quantum computer disclosed elsewhere herein. In some cases, the quantum computer may be the quantum computer 10 disclosed herein with respect to FIG. 1. In some cases, the control system of the quantum computer may be the control system 14 disclosed herein with respect to FIG. 1.

In some cases, the quantum measurements results may be stored in a storage (not shown) or a memory disclosed herein. In some cases, the memory may be the memory 22 of the digital computer 8 disclosed herein with respect to FIG. 1.

In some cases, the quantum measurement results may be provided to a digital computer. The digital computer may be of various types, such as any digital computer disclosed elsewhere herein. In some cases, the digital computer may be the digital computer 8 disclosed herein with respect to FIG. 1. The quantum measurements results may be provided using communications ports. In some embodiments, the communication ports are communications ports 28 disclosed herein with respect to FIG. 1.

In some cases, processing operations 212 and 214 may be repeated at least one time. The procedure may be repeated until the SFQ parameter values of interest can be determined. In some embodiments, the expectation value of ZI determines the parameter S. Expectation values of other Pauli operators may be selected so that θ and γ are determined.

Still referring to FIG. 2 and according to processing operation 216, the results of the quantum measurement are analyzed to infer the tunable and non-tunable model parameters' experimental values. Since the expectation values of the Pauli operators and the SFQ pulse parameters (tunable) and the fabrication (non-tunable) parameters are connected, the device parameters may be determined from the experiment. In some embodiments, the ideal value of δ_{ideal} and the experimentally obtained value of δ are compared. If δ_{ideal} and δ do not match, the type of SFQ pulses and their schedules may be updated so that δ becomes close to δ_{ideal}.

In some cases, the results of the quantum measurement may be analyzed using a digital computer. The digital computer may be of various types, such as any digital computer disclosed elsewhere herein. In some cases, the digital computer may be the digital computer 8 disclosed herein with respect to FIG. 1. The analysis results may be stored in a storage (not shown) or a memory disclosed herein. In some cases, the memory may be the memory 22 disclosed herein with respect to FIG. 1 of the digital computer 8.

In some cases, the method disclosed with respect to FIG. 2 may be used for coherent noise characterization using SFQ control. In some cases, the use of the method disclosed with respect to FIG. 2 for coherent noise characterization may comprise obtaining one or more target single- and multi-qubit operations; and using the one or more target single- and multi-qudit operations to design the one or more quantum circuits in processing operation 208. In some cases, the use of the method disclosed with respect to FIG. 2 for coherent noise characterization may comprise adjusting the experimental values of the tunable parameters with respect to the one or more target single- and multi-qubit operations' values. In some embodiments, determining a deviation of a rotation angle of a single-qubit Rx gate from π/2 is of interest. In some cases, the actual Rx rotation may be described by

$$exp [ - i ( \frac{( \frac{π}{2} + α )}{2} ) {σ}_{x} ] .$$

The circuit which enables the determining of the value α is a circuit which applies the Rx gate L times.

In some cases, the use of the method disclosed with respect to FIG. 2 for coherent noise characterization comprises repeating processing operations 212 and 214 at least one time. Expectation values of the Pauli operators may be described as a function of the repetition numbers. Therefore, by Fourier transforming the expectation values of Pauli operators, the parameter values that may be realized on quantum computers can be determined.

In some cases, the use of the method disclosed with respect to FIG. 2 for coherent noise characterization comprises repeating processing operations 210, 212, 214, and 216 with the adjusted parameters' values at least one time. In some embodiments, the Rx gate is applied L times, and the expectation value of Pauli-Z is measured. Then the value of L is changed, and the procedure is repeated. Various values of L may be considered.

In some cases, the use of the method disclosed with respect to FIG. 2 for coherent noise characterization comprises repeating processing operations 208, 210, 212, 214, and 216 with the adjusted parameters' values at least one time. In some embodiments, the Rx gate is applied L times, and the expectation value of Pauli-Z is measured. Then the value of L is changed, and the procedure is repeated. Various values of L may be considered.

In some cases, the method disclosed with respect to FIG. 2 may be used for the characterization of hardware fabrication defects using SFQ control. In some embodiments, a qubit Hamiltonian and an SFQ Hamiltonian are given by

$${H}_{free} = \frac{ℏ w}{2} ( 1 - {σ}_{z} )$$

$${H}_{S F Q} = {C}_{c} V ( t ) \sqrt{\frac{ℏ w}{2 C}} {σ}_{x} ,$$

where C_{c} is the coupling capacitance between an SFQ driver and a qubit, C is the qubit's self-capacitance, and V(t) is a time-dependent voltage source. When an SFQ pulse is sent, the qubit's state is rotated by the angle

$$δθ = {C}_{c} {Φ}_{0} \sqrt{\frac{2 w}{ℏ C}} .$$

A sequence of SFQ pulses may be sent so that the rotation angle becomes π/2.

In some cases, the method disclosed with respect to FIG. 2 may be used for performing calibration of single- and multi-qubit operations using SFQ control. In some embodiments, a single qubit operation is generated by a Hamiltonian

$$H = {C}_{c} V ( t ) \sqrt{\frac{ℏ w}{2 c}} {σ}_{x}$$

and the resultant gate operation is exp(−iθσₓ). SFQ control may determine the rotation angle θ.

In some cases, in the methods and systems disclosed herein with respect to FIG. 1 and FIG. 2, at least one qudit of the plurality of qudits may be controlled with an analog pulse. In some embodiments, an XX+YY coupling in a two-qubit Hamiltonian is turned on. The resultant gate operation is given by exp[−iφ(XX+YY)]. The value of φ may be determined by the shape, strength, and duration of an analog pulse.

In some cases, in the methods and systems disclosed herein with respect to FIG. 1 and FIG. 2, a multi-qudit gate may comprise one or more multi-qudit couplings. In some embodiments, a two-qubit gate operation \sqrt{iSWAP} is given by successive applications of a single-qubit gate Z⊗I, a two-qubit gate operation \sqrt{iSWAP^{†}}, and another single-qubit gate Z⊗I. In some cases, multi-qudit couplings may be executed using an analog pulse. In some embodiments, an SFQ-analog hybrid two-qubit gate operation \sqrt{iSWAP} are applied by applying SFQ-based single-qubit gate operations Z⊗I and an analog \sqrt{iSWAP^{†}} two-qubit gate operation.

The results obtained through the disclosed methods may be used for quantum error correction. In quantum error correction, an error correcting code that is represented using logical information may be encoded in multiple physical qudits. Some embodiments of error correcting codes are CSS codes and topological codes, including surface code, colour code, triangular colour code, rotated surface code, and toric code. The purpose of this encoding is to suppress the error rate of logical qudits rather than that of individual physical qudits. In order for quantum error correction to be successful, it may be useful to be able to estimate the logical error rate as well as the threshold error rate below which the logical error rate is smaller than the physical error rate. In some embodiments, in order to estimate the logical error rate, a classical simulation of parity check circuits in error correcting codes is performed with a noise model obtained through quantum channel characterization via experimentation. The values of tunable and non-tunable parameters of quantum gates obtained using methods and systems disclosed herein may become a part of the noise model used in this classical simulation.

Another application of the error model obtained using methods and systems disclosed herein and, in particular, a quantum channel characterization method disclosed herein is to calculate the probability of individual errors in the decoding process. In quantum error correction, information is obtained by measuring syndrome qubits and the decoding process is used to estimate errors to prescribe recovery operations. A topologically equivalent class of errors with the highest likelihood of the syndrome information may be estimated. This process comprises generation of weighted graphs, where each edge is assigned a weight based on the probability of an error occurring on that edge. The error model from the disclosed methods may provide more-accurate values of such weights, which may result in a higher success rate of quantum error correction.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for performing phase estimation of single- and multi-qudit gate operations using single-flux quantum (SFQ) control, said method comprising:
(a) obtaining an indication of a plurality of qudits, wherein at least one qudit of said plurality of qudits is controlled with said SFQ control;
(b) obtaining an indication of a model representative of said plurality of qudits and single- and multi-qudit gate operations, wherein said model comprises one or more tunable parameters;
(c) designing one or more quantum circuits based at least in part on said one or more tunable parameters of said model;
(d) setting SFQ control parameters based at least in part on values of said one or more tunable parameters of said model;
(e) executing said one or more quantum circuits using at least said SFQ control parameters set in (d); and
(f) inferring experimental values of said tunable parameters of said model based at least in part on results of a quantum measurement of one or more qudits of said one or more quantum circuits, wherein said phase estimation is based at least in part on said experimental values.

2. The method of claim 1, wherein said model comprises one or more non-tunable parameters, and wherein (c) further comprises designing said one or more quantum circuits based at least in part on said one or more non-tunable parameters; and wherein (f) further comprises inferring experimental values of said non-tunable parameters of said model based at least in part on said results of said quantum measurement.

3. The method of claim 1, wherein (e) and said quantum measurement of said one or more qudits of said circuit are repeated at least one time.

4. The method of claim 1, wherein at least one of said tunable parameters or non-tunable parameters of said model are representative of at least one member selected from the group consisting of said SFQ control parameters, hardware fabrication properties, and a modulation schedule for current and voltage in a control line.

5. The method of claim 4, wherein said non-tunable parameters are representative of said hardware fabrication properties, and wherein the method further comprises characterizing hardware fabrication defects using said SFQ control.

6. The method of claim 1, wherein said SFQ control parameters comprise at least one member of the group consisting of a schedule of SFQ pulses, a presence or absence of SFQ pulses according to a clock, and a length of a sequence of SFQ pulses.

7. The method of claim 1, wherein the method further comprises (i) obtaining one or more target single- and multi-qudit gate operations; (ii) using said one or more target single- and multi-qudit gate operations to design said one or more quantum circuits in (c); and (iii) characterizing coherent noise based at least in part on said quantum measurement.

8. The method of claim 7, further comprising (iv) adjusting said experimental values of said tunable model parameters in (f) with respect to said target single- and multi-qudit gate operations' values.

9. The method of claim 8, wherein (d) to (f) or (c) to (f) are repeated with said experimental values of said tunable parameters adjusted in (iv).

10. The method of claim 1, further comprising performing calibration of said single- and multi-qudit gate operations based at least in part on said tunable parameters or non-tunable parameters of said model.

11. The method of claim 1, wherein said plurality of qudits comprises at least one member of the group consisting of superconducting qudits, transmon qudits, flux qudits, fluxonium qudits, Cooper-pair boxes, quantronium qudits, phase qudits, hybrid qudits, and cat qudits.

12. The method of claim 1, wherein said single- and multi-qudit gate operations comprise at least one member of the group consisting of a single-qudit rotation gate, a single-qudit Clifford gate, a multi-qudit Clifford gate, a CNOT gate, a Pauli gate, an iSWAP gate, and a CZ gate.

13. The method of claim 1, wherein at least one qudit of said plurality of qudits is controlled with an analog pulse.

14. The method of claim 1, wherein said multi-qudit gate comprises one or more multi-qudit couplings, and wherein the method further comprises executing said one or more multi-qudit couplings using an analog pulse.

15. The method of claim 1, wherein said plurality of qudits comprises an error correction code.

16. The method of claim 15, further comprising performing an error correction procedure using said error correction code, wherein said error correction procedure is based at least in part on said experimental values of said tunable parameters or experimental values of non-tunable parameters of said model.

17. The method of claim 16, wherein said error correction code comprises Calderbank-Shor-Steane (CSS) code, surface code, colour code, triangular colour code, rotated surface code, or toric code.

18. The method of claim 15, further comprising performing a plurality of parity checks on a plaquette in said error correction code.

19. A system for performing robust phase estimation of single- and multi-qudit gate operations using single-flux quantum (SFQ) control, the system comprising:
(a) a digital computer operatively coupled to a quantum computer, said digital computer comprising a memory having instructions to at least:
(i) obtain an indication of a plurality of qudits, wherein at least one qudit of said plurality of qudits is controlled with said SFQ control;
(ii) obtain an indication of a model representative of said plurality of qudits and said single- and multi-qudit gate operations, wherein said model comprises one or more tunable parameters;
(iii) design one or more quantum circuits based at least in part on said one or more tunable parameters of said model;
(iv) set SFQ control parameters based at least in part on values of said one or more tunable parameters of said model;
(v) execute said one or more quantum circuits using at least said SFQ control parameters set in (iv); and
(vi) infer experimental values of said tunable parameters of said model based at least in part on results of a quantum measurement of one or more qudits of said one or more quantum circuits, wherein said phase estimation is based at least in part on said experimental values.

20. The system of claim 19, further comprising a quantum computer, wherein said quantum computer comprises a quantum chip comprising said plurality of qudits and a control system, wherein at least one qudit of said plurality of qudits is controlled with said SFQ control.
